(19) United States
(12) Patent Application Publication
(10) Pub. No.: US 2009/0270008 A1
(43) Pub. Date: Oct. 29, 2009

(54) METHOD FOR PRODUCING DISPLAY ELEMENT

(76) Inventors: Yasushi KAWATA, Ageo-shi (JP); Azusa Ikeda, Fukaya-shi (JP); Akio Murayama, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/400,455

(22) Filed: Mar. 9, 2009

(30) Foreign Application Priority Data
Apr. 25, 2008 (JP) 2008-115574

(51) Int. Cl. H01J 9/20

(52) U.S. Cl. 445/58

(57) ABSTRACT

A stopper layer and a plurality of pixels are formed on a large-sized glass substrate by a conventional production process. An intermediate panel is formed by adhering a counter large-sized non-glass substrate onto the large-sized glass substrate. The large-sized glass substrate and the stopper layer are removed. A thinner film-shaped array large-sized non-glass substrate than the large-sized glass substrate is adhered to the counter large-sized non-glass substrate via an adhesive layer. It is possible to produce components including and up to the intermediate panel by using a conventional production process when transferring pixels (thin film transistor layer) onto the array large-sized non-glass substrate. Thinning and lightening of the liquid crystal display panel 11 can be achieved while preventing a remarkable increase in change in the production process and an increase in the number of indirect members.

### INCORPORATION BY REFERENCE

The present application claims priority under 35 U.S.C. §119 to Japanese Patent Application No. 2008-115574 filed on Apr. 25, 2008. The content of the application is incorporated herein by reference in its entirety.

### FIELD OF THE INVENTION

The present invention relates to a method for producing a display element having a pair of non-glass substrates opposed and adhered to each other.

### BACKGROUND OF THE INVENTION

Conventionally, a planar display element represented by, for example, a liquid crystal display panel being a liquid crystal display element has been utilized in various fields such as office automation equipment, information terminals, watches, television sets, etc., utilizing the characteristics of lightweight, thinness, and low power consumption. Among these, a liquid crystal cell using a thin-film transistor (TFT) has been widely used as a display element, which displays a great amount of information, such as a mobile terminal and a computer by virtue of its high responsiveness.

In recent years, a thinner and lighter display element has been demanded in view of not only performance but also design and portability in mobile information terminal equipment such as a mobile telephone and a PDA (Personal Digital Assistant).

Therefore, for example, there is a liquid crystal cell that can achieve a further thinner structure. Generally, a silica substrate and a glass substrate have been used in view of such as heat resistance for a substrate material that forms a thin film transistor. Thinning and lightening thereof have been attempted to mechanically or chemically polish these substrates. As a method for further lightening, for example, as described in Japanese Laid-Open Patent Publication No. 2007-311541, a new attempt has been considered, by which the glass substrate is once removed and only a thin film transistor (TFT thin film) is transferred onto another light resin substrate.

However, in order to transfer a thin film transistor, there is a concern about an increase in production costs by providing or increasing intermediate members such as a support substrate, a chemical-shielding film, a temporary adhesive, etc., for the purpose of preventing the thin film transistor from being curved due to residual stress, etc., improving the chemical-resistant properties in production processes and facilitating handling thereof. Further, since a new facility used for assembling a liquid crystal panel using a filmed substrate is required, it is necessary to change or alter the conventional production processes to a large extent.

The present invention has been developed in view of such points, and it is therefore an object of the invention to provide a method for producing a display element for which thinning and lightening are achieved while preventing the conventional production processes from being subjected to large-scale change or alteration.

### SUMMARY OF THE INVENTION

The present invention relates to a method for producing a display element, including a pixel forming step of forming a removal preventing layer on a glass substrate and a plurality of pixels on the removal preventing layer, respectively; a first adhering step of forming an intermediate body by adhering a counter non-glass substrate to the glass substrate; a first removing step of removing the glass substrate from the intermediate body; a second removing step of removing the removal preventing layer from the intermediate body after the first removing step; and a second adhering step of adhering an array non-glass substrate to an array side of the intermediate body after the second removing step. And, after the removal preventing layer is formed on the glass substrate, a plurality of pixels are formed on the removal preventing layer, respectively, and an intermediate body is formed by adhering a counter non-glass substrate to the glass substrate, the glass substrate and the removal preventing layer are removed from the intermediate body, and the array non-glass substrate is adhered to the counter non-glass substrate, wherein, when transferring pixels formed on the glass substrate onto an array non-glass substrate, since a conventional production process can produce components up to an intermediate body in which a counter non-glass substrate is adhered to a glass substrate, thinning and lightening can be achieved while preventing large changes in the conventional production processes.

In addition, the present invention relates to a method for producing a display element, including a pixel forming step of forming respectively at least a plurality of pixels on a glass substrate, a first adhering step of forming an intermediate body by adhering a counter non-glass substrate to the glass substrate, a polishing step of bringing about a thin layer with a predetermined thickness remaining by polishing the glass substrate, and a second adhering step of adhering an array non-glass substrate to the thin layer. And, after at least a plurality of pixels are respectively formed on the glass substrate and an intermediate body is formed by adhering the counter non-glass substrate to the glass substrate, a thin layer is brought about with a predetermined thickness remaining by polishing the glass substrate, and the array non-glass substrate is adhered to the thin layer, wherein, when transferring pixels formed on the glass substrate onto an array non-glass substrate, since a conventional production process can produce up to an intermediate body in which a counter non-glass substrate is adhered to a glass substrate, thinning and lightening can be achieved while preventing large changes in the conventional production processes.

### BRIEF DESCRIPTION OF THE DRAWINGS

FIG. 1 is a schematic sectional view showing an intermediate body formed by a pixel forming step through a first adhering step of a method for producing a display element according to Embodiment 1 of the invention;

FIG. 2 is a schematic plan view showing the intermediate body;

FIG. 3 is a schematic sectional view showing the first removing step of the method for producing a display element;

FIG. 4 is a schematic sectional view showing the second adhering step of the method for producing a display element;

FIG. 5 is a schematic perspective view showing a display element produced by the method for producing a display element;

FIG. 6 is a schematic sectional view showing an intermediate body formed by a pixel forming step through a first adhering step of the method for producing a display element according to Embodiment 2 of the invention;

FIG. 7 is a schematic sectional view showing a polishing step of a method for producing a display element; and

FIG. 8 is a schematic sectional view showing the second adhering step of a method for producing the display element.

### DETAILED DESCRIPTION OF THE PREFERRED EMBODIMENTS

Hereinafter, a description is given of a configuration of Embodiment 1 of the invention with reference to the drawings.

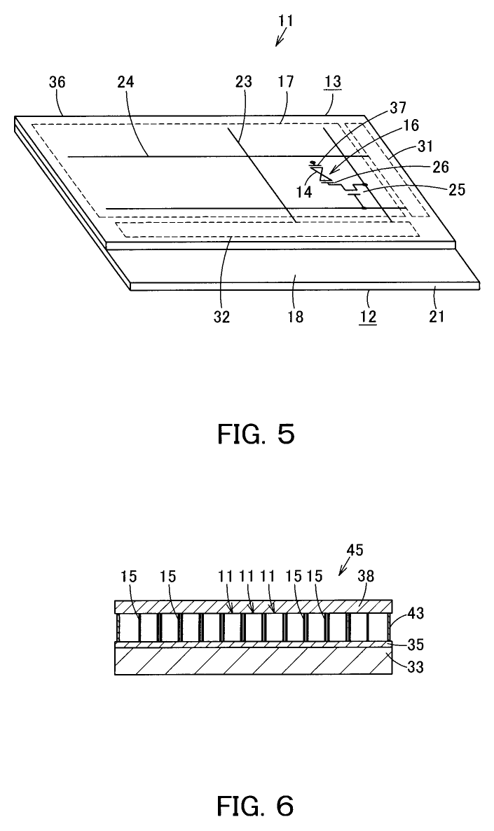

In FIG. 5, reference numeral 11 denotes a liquid crystal display panel that is a liquid crystal element as a display element. The liquid crystal display panel 11 is, for example, of an active matrix type capable of displaying colors. And, the liquid crystal display panel 11 has an array substrate 12 disposed opposite a counter substrate 13, has a liquid crystal layer 14 intervened between these substrates 12 and 13, the liquid crystal layer 14 being an optically modulating layer, and is composed with a polarization plate (not illustrated) attached to each of the substrates 12 and 13, wherein the substrates 12 and 13 are adhesively fixed to each other and adhered to a sealing portion 15 serving as an adhesive portion, an effective display portion 17 having a plurality of pixels (sub pixels) 16 disposed in the form of a matrix is formed in the interior surrounded by the sealing portion 15, and at the same time, a peripheral circuit portion 18 is formed outward of the sealing portion 15 adjacent to the effective display portion 17.

Also, hereinafter, a description is given under the assumption that the liquid crystal display panel 11 is a transmission type. However, it is a matter of course that the liquid crystal display panel 11 may be a reflection type or a semi-transmission type.

In the array substrate 12, a plurality of signal lines 23 and scanning lines 24 are disposed in a grid pattern on the main side of the inner side of the effective display portion 17 on the non-glass substrate 21 being an insulative substrate, and a thin film transistor (TFT) 25 operating as a switching element is disposed so as to correspond to respective intersections of the signal lines 23 and the scanning lines 24. In addition, a color filter layer (not illustrated) being a coloring layer is formed on the non-glass substrate 21, and a pixel electrode 26 that is driven by the thin film transistor 25 is disposed on the color filter layer. Further, a transfer electrode (not illustrated) that electrically connects the array substrate 12 side and the counter substrate 13 side together is formed in the vicinity of four corners of the sealing portion 15 on the non-glass substrate 21, and at the same time, a wiring pad portion (not illustrated) that connects the array substrate 12 to peripheral circuits is formed thereat.

The non-glass substrate 21 is a high heat-resistant property resin substrate formed of, for example, aramid resin, polyimide resin, or a hybrid resin composed of epoxy resin and glass fiber. That is, PES (Product brand name), PEN (Product brand name) or Neoprim (Product brand name), etc., may be favorably used. However, if a specified material has a desired transmission ratio, heat resistance, and chemical resistance, etc., as the substrate composing the liquid crystal display panel 11, the material may be generally used. And, the non-glass substrate 21 has, for example, 0.2 mm thickness or less, and has 0.1 mm thickness in the present embodiment. The non-glass substrate 21 is composed by cutting it out from an array large-sized non-glass substrate 28, which is an array non-glass substrate as a large-sized mother substrate when producing them.

The signal lines 23 and the scanning lines 24 are formed of a metallic material having conductivity, etc., respectively. Also, the signal lines 23 are formed along the vertical direction, and the scanning lines 24 are formed along the horizontal direction.

The thin film transistor 25 has a gate electrode formed so as to protrude from the scanning line 24, has a source electrode formed so as to protrude from the signal line 23, and has a drain electrode connected to a pixel electrode 26 via a contact hole (not illustrated). Since a drive signal (operation signal) supplied from a gate driver 31 being a scanning line drive circuit is applied on the gate electrode via the scanning line 24, switching is controlled. Since voltage is applied to the pixel electrode 26 corresponding to a drive signal (picture signal) input from a source driver 32 being a signal line drive circuit via the signal line 23, the pixels 16 can be independently turned on and off, respectively. The structure of the thin film transistor 25 may be composed to be an inorganic film in all layers by, for example, aluminum (Al), silicon nitride film (SiNx), ITO (Indium Tin Oxide), polysilicon (p-Si), amorphous silicon (a-Si), copper (Cu), Molybdenum (Mo), tantalum (Ta), tungsten (W), silicon oxide film (SiOx), etc. However, where the self-supporting property in polishing a large-sized glass substrate 33 as a glass substrate is taken into consideration, in addition to the above described inorganic film, it is preferable that the structure is an inorganic/organic hybrid thin-film structure including an organic thin film having flexibility such as an acryl resin, epoxy resin, silicone resin, etc., in a stacked structure.

In particular, it is important in composing a high-definition display element using a non-glass substrate that the inorganic/organic hybrid thin film is a COA structure. Since, in the counter color filter structure being the conventional configuration, it is necessary to position the color filter disposed at the side opposed to the array substrate and the pixels at the array substrate side at high accuracy, it is not easy to use a non-glass substrate having the dimensional accuracy of which is influenced by heat and moisture. Under such situations, there is a problem by which the yield is lowered because the cell process according to the present invention is applicable by only an unrealistic method of removing only the glass substrate from display elements of the conventional configuration in which a pixel array on the glass substrate having favorable dimensional accuracy is adhered to the color filter on the glass substrate. On the contrary, since almost no adhering accuracy is required between the counter substrate and the array substrate side in the COA structure, it is possible to use a non-glass substrate having lower dimensional accuracy for the counter substrate in advance, wherein the process according to the present invention is easily applicable. That is, since the yield of the COA structure has improved in recent years and can be sufficiently used as a mass-production process, the present invention can be carried out.

As the configurational example of the inorganic organic hybrid thin film, there is a color filter on-array (COA) structure in which the color filter layer is formed by patterning RGB coloring resist materials or a pixel superimposing structure in which the opening ratio is attempted to be improved by separating the pixel electrode 26 and the thin film transistor 25 from each other by a transparent resist material.

Further, in order to improve the self-supporting property of the thin film transistor 25, etc., a structure of overcoating by the coloring resist material and the transparent resist material on the peripheral circuit portion 18 is preferable.

The pixel electrode 26 is formed to be roughly square by a transparent conductive material such as, for example, ITO. And, the signal lines 23, scanning lines 24, thin film transistor 25, color filer layer and pixel electrode 26 (pixels 16) are formed on the large-sized glass substrate 33 by a common production process when producing them, and are transferred on the array large-sized non-glass substrate 28 via the adhesive layer 34. In addition, hereinafter, the layer including these signal lines 23, scanning lines 24, and thin film transistor 25, etc., is called a “thin film transistor layer 35” as a whole.

The large-sized glass substrate 33 is removed by chemical or mechanical polishing when producing them.

On the other hand, the counter substrate 13 is provided with a common electrode 37 being a counter electrode, which is disposed opposite to the pixel electrode 26 on the main side of the inner side by the effective display portion 17, on the non-glass substrate 36 being an insulative substrate.

The non-glass substrate 36 is a high heat-resistant property resin substrate that is formed of the same material as the non-glass substrate 21, that is, for example, aramid resin, polyimide resin or a hybrid resin of epoxy resin and glass fibers, wherein PES (Product brand name), PEN (Product brand name) or Neoprim (Product brand name), etc., may be favorably used. However, if a specified material has a desired transmission ratio, heat resistance, and chemical resistance, etc., as the substrate composing the liquid crystal display panel 11, the material may be generally used. And, the non-glass substrate 36 has, for example, 0.2 mm thickness or less, and has 0.1 mm thickness in the present embodiment. The non-glass substrate 36 is composed by cutting it out from a counter large-sized non-glass substrate 38, which is a counter non-glass substrate as a large-sized mother substrate when producing them.

The common electrode 37 is formed to be roughly square by a transparent conductive material such as, for example, ITO.

The liquid crystal layer 14 is an optically modulating layer formed by a predetermined liquid crystal material.

The sealing portion 15 may use various types of adhesives such as, for example, a light (for example, an ultraviolet ray) curing type.

Next, a description is given of a method for producing a display element according to Embodiment 1 described above.

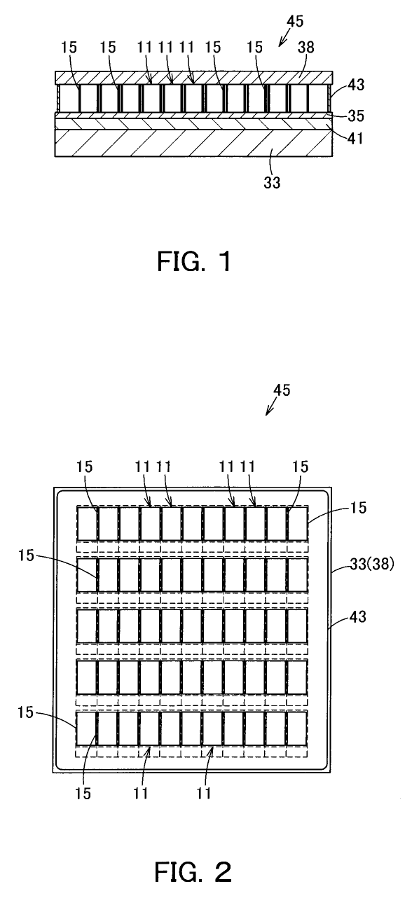

First, as shown in FIG. 1 and FIG. 2, after forming a stopper layer 41 being a polishing prevention layer as a removal preventing layer on a large-sized glass substrate 33 using a common array production process in which film formation and patterning are repeated, a thin film transistor layer 35 such as the signal lines 23, scanning lines 24, thin film transistor 25, color filter layer, and pixel electrodes 26 (pixels 16) are formed at respective positions on the large-sized glass substrate 33 (Pixel forming step). Here, the stopper layer 41 is formed so that the thin film transistor layer 35 can withstand against chemical solutions (such as ammonium fluoride, etc.) used for chemical polishing of the large-sized glass substrate 33. It is preferable that a fluorinated acid-resistant thin film such as, for example, amorphous silicon (a-Si) thin film, etc., is used as the stopper layer 41 therefor.

Next, the common electrode 37, etc., is formed on the counter large-sized non-glass substrate 38 (Counter forming step).

After that, the large-sized glass substrate 33 and the counter large-sized non-glass substrate 38 are adhered to each other (First adhering step). In detail, for example, an ODF (One drop fill) process being a common liquid crystal drop process etc., is used for the first adhering step. That is, after the seal portion 15 being a present sealing material that covers respective effective display portions 17 by a predetermined sealing material (adhesive) and a temporary sealing portion 43 being a temporary sealing material that covers all the effective display portions 17 along the outer edge of the large-sized glass substrate 33 and the counter large-sized non-glass substrate 38 are formed, a liquid crystal material that composes respective liquid crystal layers 14 is dropped in the sealing portions 15 on the large-sized glass substrate 33, wherein the large-sized glass substrate 33 and the counter large-sized non-glass substrate 38 are adhered to each other with a predetermined clearance in a vacuumed state. As a result, an intermediate panel 45 that is an intermediate body is formed. Also, the temporary sealing portion 43 can use various types of adhesives such as a light (for example, an ultraviolet ray) curing type as in the sealing portion 15, and the adhesive is cured by irradiating light of a predetermined wavelength.

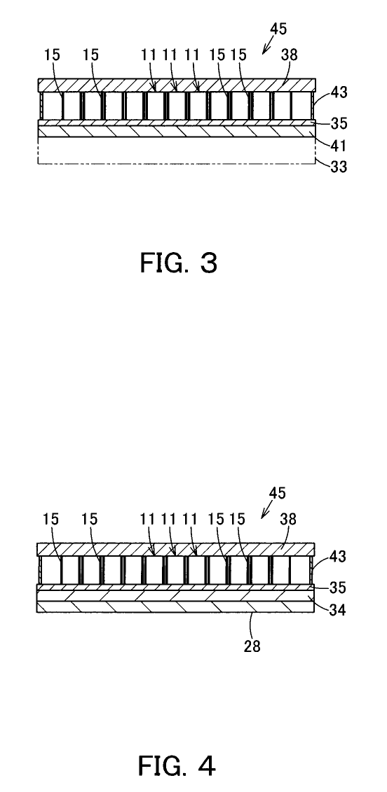

Subsequently, as shown in FIG. 3, the outer side of the large-sized glass substrate 33 is removed by chemically or mechanically polishing the side with respect to the intermediate panel 45 in which the large-sized glass substrate 33 and the counter large-sized non-glass substrate 38 are integrated (First removing step). In the first removing step, common mechanical polishing, chemical polishing using chemicals, and complex polishing in which these are alternately used may be carried out. Where the thin film transistor 25 (thin film transistor layer 35) is of a very thin structure (for example, 1 through 5 μm thick), a method for completely removing the remaining large-sized glass substrate 33 by chemical polishing after the processing efficiency (through-put) of the polishing is increased by roughing based on mechanical polishing is preferable as the process according to the present embodiment.

For example, a fluorinated acid solution is prepared as a polishing solution used for chemical polishing, the glass surface of the large-sized glass substrate 33 is polished by immersing the same in the polishing solution. Therefore, the surface of the large-sized glass substrate 33 is dissolved, and is chemically turned into water glass. At this time, since the surface of the large-sized glass substrate 33 is protected by water glass, the large-sized glass substrate 33 is rocked from time to time to peel off water glass, wherein a new substrate surface is exposed.

And, the intermediate panel 45 is taken out from the fluorinated acid solution at the point of time when polishing is carried out to a preset stopper layer 41, and water glass and the fluorinated acid solution, which remain on the surface of the large-sized glass substrate 33, are removed by running water. Thus, the polishing process of the first removing step is completed. At this time, since the outside of the portion corresponding to all the liquid crystal display panel 11 is sealed by the temporary sealing portion 43, there is no case where a polishing solution invades the peripheral circuit portions 18 when carrying out such chemical polishing processing.

Continuously, the stopper layer 41 is removed from the intermediate panel 45, from which all of the large-sized glass substrate 33 is removed, by using a solution such as, for example, an alkali solution (TMAH), etc., (Second removing step).

And, as shown in FIG. 4, after an adhesive layer 34 is coated on the side having the thin film transistor layer 35 side exposed, an array large-sized non-glass substrate 28 is adhered (Second adhering step).

After that, the substrate is divided cell by cell by design in which the effective display portion 17 and the peripheral circuit portion 18 are left (Dividing step). As the dividing step, scribing is used by utilizing a cutting apparatus such as a CO₂ laser or secondary through quaternary higher harmonic YAG laser, etc., which is capable of cutting the respective substrates 28, 38, thin film transistor layer 35 and a color filter layer, etc., collectively.

And, by adhering optical elements such as light polarizers, etc., to respective cells that are made individual, a liquid crystal display panel 11 is composed (Adhering step).

Thus, Embodiment 1 described above is composed, in which, after the stopper layer 41 is formed on the large-sized glass substrate 33 by a conventional production process, a plurality of pixels 16 are formed on the stopper layer 41, and the intermediate panel 45 is formed by adhering the counter large-sized non-glass substrate 38 to the large-sized glass substrate 33, the large-sized glass substrate 33 is chemically or mechanically removed, the stopper layer 41 is further removed, and a thin film array large-sized non-glass substrate 28, which has a thinner film than the large-sized glass substrate 33, is adhered to the counter large-sized non-glass substrate 38 side via the adhesive layer 34.

That is, with such a method for producing the liquid crystal display panel 11, it is possible to produce, by the conventional production process, the intermediate panel 45 to which a counter large-sized non-glass substrate 38 is adhered as the counter substrate when transferring pixels 16 (thin film transistor layer 35) to the array large-sized non-glass substrate 28. Therefore, thinning and lightening of the liquid crystal display pane 11 can be achieved while preventing the production process from being greatly changed, and preventing the number of indirect members from being increased, wherein the yield ratio can be prevented from being lowered and the production costs can be reduced.

Further, since a liquid crystal layer 14 is formed by dropping a liquid crystal material between the large-sized glass substrate 33 and the counter large-sized non-glass substrate 38 when forming the intermediate panel 45, the self-supporting characteristics of the thin film transistor layer 35 is further improved in the structure according to the present embodiment, in which a liquid crystal material is filled up in the gap between the thin film transistor layer 35 and the counter large-sized non-glass substrate 38 than in the structure in which there is a gap between the thin film transistor layer and the counter large-sized non-glass substrate, in the first removing step for removing the large-sized glass substrate 33. And it becomes easy to keep uniform the distance (cell gap) between the thin film transistor layer 35 and the counter large-sized non-glass substrate 38.

Further, although there is a fear that wiring pads of the liquid crystal display panel 11, transfer electrodes or peripheral circuit portions 18 are damaged by a polishing material or a chemical solution in the first removing step for polishing and removing the large-sized glass substrate 33, the wiring pads of the individual liquid crystal display panels 11, transfer electrode portions or peripheral circuit portions 18 can be protected by temporary sealing portion 43 by forming the temporary sealing portions 43 at the outer edge portion of the intermediate panel 45 to prevent the polishing material and chemical solution from invading after the respective liquid crystal display panel 11 is formed in the intermediate panel 45 by a drop-filling system, wherein the yield ratio can be improved in the first removing step.

Next, a description is given of Embodiment 2 with reference to the drawings. Also, constitution and operations that are identical to those of Embodiment 1 are given the same reference numerals, and description thereof is omitted.

Embodiment 2 is such that, instead of the stopper layer 41 of Embodiment 1 described above, the large sized glass substrate 33 is left in a range larger than 0.0015 mm but smaller than 0.1 mm.

First, as shown in FIG. 6, an intermediate panel 45 is formed by the pixel forming process according to the above described Embodiment 1 and by respective processes as in the first adhering step.

Continuously, a thin plate layer 47 having a predetermined thickness, for example, 0.05 mm thickness remaining is obtained by polishing the outer side of the large-sized glass substrate 33 of the intermediate panel 45 by, for example, a chemical polishing process (Polishing step). In detail, for example, a fluorinated acid solution is prepared as a polishing solution, and the large-sized glass substrate 33 is immersed in the polishing solution to polish the back side thereof, wherein the outside of the large-sized glass substrate 33 is dissolved and is chemically changed to water glass, and the large-sized glass substrate 33 is rocked from time to time to peel off water glass in order to protect the outside of the large-sized glass substrate 33. Then, the outside of a new large-sized glass substrate 33 is exposed.

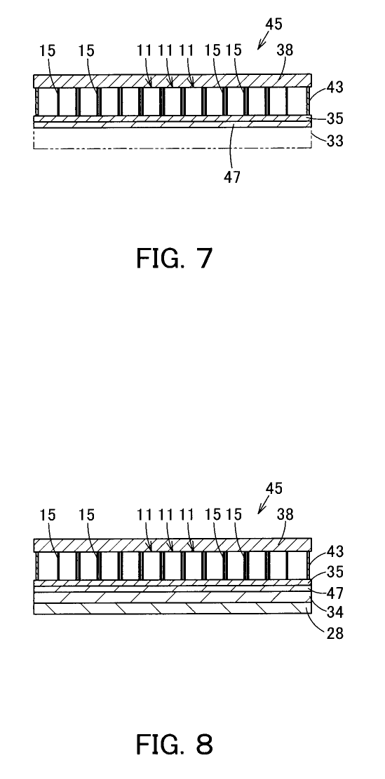

And, as shown in FIG. 7, after the thin plate layer 47 is formed, the intermediate panel 45 is taken out from the fluorinated acid solution, water glass and fluorinated acid solution, which exist on the outside of the thin plate layer 47, are removed by running water. Then, the polishing process is completed. At this time, since the outside of the portion corresponding to all of the liquid crystal display panel 11 is sealed by the temporary sealing portion 43, there is no case where the polishing solution invades the peripheral circuit portion 18 when carrying out such a chemical polishing process.

Next, as shown in FIG. 8, an array large-sized non-glass substrate 28 is adhered to the thin plate layer 47 of the intermediate panel 45 after the adhesive layer 34 is coated (Second adhering step).

And, the liquid crystal display panel 11 is composed by respective steps similar to the dividing step and the adhering step in Embodiment 1 described above.

Thus, in Embodiment 2 described above, after a plurality of pixels 16 are, respectively, formed on the large-sized glass substrate 33 by a conventional production process, and the intermediate panel 45 is formed by adhering the counter large-sized non-glass substrate 38 to the large-sized glass substrate 33, the large-sized glass substrate 33 is polished and is made into a thin plate layer 47 with a predetermined thickness remaining, and a thinner film-shaped array large-sized non-glass substrate 28 than the large-sized glass substrate 33 is adhered to the thin plate layer 47.

That is, with such a method for producing the liquid crystal display panel 11, it is possible to produce, by the conventional production process, the intermediate panel 45 to which a counter large-sized non-glass substrate 38 is adhered as the counter substrate when transferring pixels 16 (thin film transistor layer 35) to the array large-sized non-glass substrate 28. Therefore, respective operations and effects similar to those of Embodiment 1 described above can be brought about, by which thinning and lightening of the liquid crystal display panel 11 can be achieved while preventing the production process from being greatly changed, and preventing the number of indirect members from being increased, wherein the yield ratio can be prevented from being lowered and the production costs can be reduced.

Since the stopper layer 41 according to Embodiment 1 is not required any longer by the thin plate layer 47 remaining with all of the large-sized glass substrate 33 not being removed, the second removing step using an alkali solution (TMAH) may be omitted, it becomes possible to reduce the number of production processes.

In addition, in the respective embodiments, the liquid crystal display panel 11 and the respective steps are not limited to the above, but may be subjected to arbitrary modifications and variations of components that can be embodied within the scope not departing from the gist thereof.

Also, various inventions may be formed by appropriate combinations of a plurality of components disclosed in the respective embodiments described above. For example, some components may be omitted from all the components shown in the respective embodiments described above. Further, components pertaining to different embodiments may be appropriately combined.

What is claimed is:

1. A method for producing a display element, comprising:
a pixel forming step of forming a removal preventing layer on a glass substrate and a plurality of pixels on the removal preventing layer, respectively;
a first adhering step of forming an intermediate body by adhering a counter non-glass substrate to the glass substrate;
a first removing step of removing the glass substrate from the intermediate body;
a second removing step of removing the removal preventing layer from the intermediate body after the first removing step; and
a second adhering step of adhering an array non-glass substrate to an array side of the intermediate body after the second removing step.

2. A method for producing a display element, comprising:
a pixel forming step of forming respectively at least a plurality of pixels on a glass substrate;
a first adhering step of forming an intermediate body by adhering a counter non-glass substrate to the glass substrate;
a polishing step of polishing the glass substrate and making the glass substrate into a thin film layer with a predetermined thickness remaining; and
a second adhering step of adhering an array non-glass substrate to the thin film layer.

3. The method for producing a display element according to claim 2, wherein the glass substrate is chemically polished in the polishing step.

4. The method for producing a display element according to claim 2, wherein the glass substrate is mechanically polished in the polishing step.

5. The method for producing a display element according to claim 1 or 2, wherein the counter non-glass substrate and the array non-glass substrate are made of the same material.

6. The method for producing a display element according to claim 1 or 2, wherein a liquid crystal material composing a liquid crystal layer is dropped between the glass substrate and the counter non-glass substrate when adhering the counter non-glass substrate to the glass substrate in the first adhering step.

7. The method for producing a display element according to claim 1 or 2, wherein the array non-glass substrate and the counter non-glass substrate are made of a hybrid resin consisting of glass fibers and at least any one of aramid resin, polyimide resin and epoxy resin.
